(19) United States
(12) Patent Application Publication
(10) Pub. No.: US 2026/0121555 A1
(43) Pub. Date: Apr. 30, 2026

(54) TRIBOELECTRIC NANOGENERATOR BASED ON 4D PRINTING, AND ENERGY COLLECTION APPARATUS AND PREPARATION METHOD

(71) Applicant: SHENZHEN UNIVERSITY, Guangdong (CN)

(72) Inventors: Jiancheng HAN, Guangdong (CN); Longbiao HUANG, Guangdong (CN)

(73) Assignee: SHENZHEN UNIVERSITY, Guangdong (CN)

(21) Appl. No.: 18/271,860

(22) PCT Filed: Feb. 19, 2021
(86) PCT No.: PCT/CN2021/076785

§ 371 Date: Nov. 20, 2023

(30) Foreign Application Priority Data
Jan. 12, 2021 (CN) 202110038923.6

(51) Int. Cl. H02N 1/04

(52) U.S. Cl. CPC H02N 1/04

(57) ABSTRACT

Provided is a triboelectric nanogenerator based on a 4D printing technology, including a first substrate layer and a second substrate layer arranged parallelly up and down, a first conducting layer arranged on a lower surface of the first substrate layer, a second conducting layer arranged on an upper surface of the second substrate layer, and a first friction layer arranged on a lower surface of the first conducting layer or an upper surface of the second conducting layer, wherein the first conducting layer and the second conducting layer are electrically connected; the first substrate layer, the second substrate layer and the first friction layer are formed by adopting the 4D printing technology; and the first friction layer and the second conducting layer or the first conducting layer are arranged opposite to each other, and a contacting-separating reciprocating motion is performed between the first friction layer and the second conducting layer or the first conducting layer.

### TECHNICAL FIELD

The present invention relates to the field of combining a 4D printing technology and a triboelectric nanogenerator technology, and particularly relates to a triboelectric nanogenerator based on a 4D printing technology and an energy harvesting device.

### BACKGROUND

Mass use of fossil energy accelerates global warming and energy crisis, and it is especially urgent to seek for a clean and renewable green energy to alleviate dilemma of human development. As a novel micro-nano energy harvesting technology, a triboelectric nanogenerator can convert mechanical energy into electric energy efficiently. Compared with conventional power generation technologies, the triboelectric nanogenerator features simple structure, low cost, high energy conversion efficiency and wide material selection range, and has a huge application potential in the field of mechanical energy harvesting.

In the prevailing circumstance, there are still limitations on development and application of the triboelectric nanogenerator. First of all, a conventional process to prepare the triboelectric nanogenerator often includes processing and assembling of components to finally obtain an intact triboelectric nanogenerator. However, it is hard to obtain an apparatus with complicated and elaborated structure by such a process. Secondly, since continuous friction and separate of dielectric materials are needed in a working process of the triboelectric nanogenerator, the dielectric materials may be damaged, so that the performance of the triboelectric nanogenerator is reduced, and the service life of the apparatus is shortened.

Patent literature CN108964511A (publication date: 20181207) discloses a triboelectric nanogenerator based on a 3D printing technology and a preparation method therefor. Unit structures are manufactured by using the 3D printing technology through a complicated mechanical structure design, and units of the triboelectric nanogenerator are assembled in corresponding positions to finally assemble a triboelectric nanogenerator which is high in output performance and low in cost. However, its preparation flow is complicated, the preparation efficiency and preparation precision are low, and the service life of the manufactured triboelectric nanogenerator is unsatisfactory.

To promote application and development of the triboelectric nanogenerator, it is an urgent need of a brand new process to improve the preparation efficiency and preparation precision of the triboelectric nanogenerator and prolong the service life of the triboelectric nanogenerator.

### SUMMARY

The present invention is intended to at least solve the technical problems of low preparation efficiency and precision and short service life of the apparatus to a certain extent.

The principal objective of the present invention is to provide a triboelectric nanogenerator based on a 4D printing technology.

To solve the above technical problems, the present invention adopts the following technical solution:

A triboelectric nanogenerator based on a 4D printing technology, including a first substrate layer and a second substrate layer arranged parallelly up and down, a first conducting layer arranged on a lower surface of the first substrate layer, a second conducting layer arranged on an upper surface of the second substrate layer, and a first friction layer arranged on a lower surface of the first conducting layer or an upper surface of the second conducting layer, wherein the first conducting layer and the second conducting layer are electrically connected; the first substrate layer, the second substrate layer and the first friction layer are formed by adopting the 4D printing technology; and the first friction layer and the second conducting layer are arranged opposite to each other to perform a reciprocating motion of contacting-separating, or the first friction layer and the first conducting layer are arranged opposite to each other to perform a reciprocating motion of contacting-separating.

Preferably, the first substrate layer the second substrate layer and the first friction layer are made of shape memory polymer or self-repair material.

Preferably, the printing technology is direct ink writing printing or digital photocuring.

Preferably, a volatile solution with a conducting substance is sprayed to surfaces of the first substrate layer and the second substrate layer, and the first conducting layer and the second conducting layer are obtained by volatilizing a solvent.

Preferably, the conducting substance includes a silver nanowire, a carbon nanotube or graphene.

Preferably, the first friction layer has bulges or grooves thereon.

Preferably, ends of both sides of the first substrate layer and the second substrate layer are connected by a connecting portion to form an annular structure.

Preferably, the connecting portion, the first substrate layer and the second substrate layer are integrally printed.

The further objective of the present invention is to provide a mechanical energy harvesting device, wherein the triboelectric nanogenerator based on a 4D printing technology is configured as a shoe-pad shape for harvesting mechanical energy generated by walking of a human body, and both ends of the first substrate layer and the second substrate layer have the connecting portions.

The third objective of the present invention is to provide a method for preparing a triboelectric nanogenerator based on a 4D printing technology, including the following steps:
S1: designing a contacting-separating triboelectric nanogenerator model;
S2: performing force analysis on a working process of the model after modeling and performing a simulation test on distribution of an electric potential field;
S3: importing the tested model into slicing software for slicing and layering, selecting a processing sequence according to an actual structure of the model and generating a processing instruction;
S4: importing the processing instruction into a 3D printer to perform layer-by-layer print processing of the first substrate layer, the second substrate layer and the first friction layer, respectively; if a printed product in the processing process does not meet a use requirement, returning to S1 to carry out design and simulation test of the model again and generating a novel processing instruction;
S5: spraying a volatile solution doped with a conducting substance to a lower surface of the first substrate layer and an upper surface of the second substrate layer by using a spraying machine after print processing, and volatilizing the solution to obtain the first conducting layer and the second conducting layer; and
S6: assembling the first substrate layer having the conducting layer, the second substrate layer having the conducting layer, and the first friction layer into the triboelectric nanogenerator.

Compared with the prior art, the present invention has the following beneficial effects:

1. A main body structure of the triboelectric nanogenerator is prepared by the 4D printing technology, so that the preparation flow of the triboelectric nanogenerator is simplified, and the preparation precision is improved. The printed object has the shape memory function as polyurethane has the shape memory function. When working as a functional apparatus, the shape of the apparatus can be recovered thanks to the good shape memory function when coping with performance degradation due to apparatus deformation and wear, and meanwhile, the output performance of the apparatus can be effectively recovered, so that the service life of the triboelectric nanogenerator is greatly prolonged. Meanwhile, a feasible method for preparing the shape of the surface of the apparatus is provided. The friction layer has abundant surface shapes due to the 4D printing technology, and the effective contact area of the apparatus can be increased, so that the output performance of the apparatus is improved.

2. The shoe-pad-shaped energy harvesting device prepared based on the 4D printing technology can effectively harvest mechanical energy generated by walking of the human body in the actual work and converts the mechanical energy into electric energy.

### BRIEF DESCRIPTION OF DRAWINGS

FIG. 1 is a schematic plan of a triboelectric nanogenerator based on a 4D printing technology provided in Embodiment 1 of the present invention.

FIG. 2 is a stereogram of the triboelectric nanogenerator based on a 4D printing technology provided in Embodiment 1 of the present invention.

FIG. 3 is a schematic diagram showing a change of a peak voltage with a gap width between a first friction layer and a first conducting layer or a second conducting layer of the triboelectric nanogenerator based on a 4D printing technology provided in Embodiment 1 of the present invention.

FIG. 4 shows a process of triboelectrification caused by applying a pressure to the two substrate layers first time during work of the triboelectric nanogenerator based on a 4D printing technology provided in Embodiment 1 of the present invention.

FIG. 5 shows a process where the first friction layer and the second conducting layer are getting away from each other after an external force is removed during work of the triboelectric nanogenerator based on a 4D printing technology provided in Embodiment 1 of the present invention.

FIG. 6 shows a process where the two substrate layers of the triboelectric nanogenerator based on a 4D printing technology provided in Embodiment 1 of the present invention are recovered to initial positions.

FIG. 7 shows a process of applying the pressure to the two substrate layers again during work of the triboelectric nanogenerator based on a 4D printing technology provided in Embodiment 1 of the present invention.

FIG. 8 is a variation diagram of an output voltage provided in Embodiment 1 of the present invention.

FIG. 9 is a stereogram of an energy harvesting device provided in Embodiment 2 of the present invention.

FIG. 10 is a variation diagram of an output voltage provided in Embodiment 2 of the present invention.

FIG. 11 is a flow chart of steps of a method for preparing a triboelectric nanogenerator based on a 4D printing technology provided in Embodiment 3 of the present invention.

### DETAILED DESCRIPTION OF EMBODIMENTS

The drawings are merely used for exemplary description and are not construed as limitation to the patent.

In order to better describe the embodiments, some parts in the drawings will be omitted, amplified or lessened and the drawings do not represent the dimensions of actual products.

For those skilled in the art, it can be understood that some known structures and description thereof in the drawings may be omitted.

The technical solution of the present invention will be further described below in combination with the drawings and the embodiments.

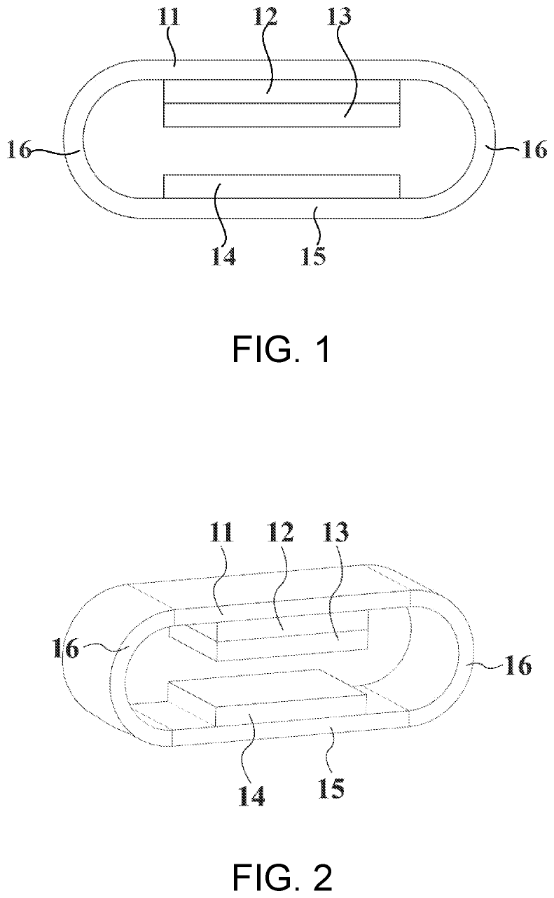

Referring to FIGS. 1-2, a triboelectric nanogenerator based on a 4D printing technology provided in the embodiment includes substrate layers, including a first substrate layer 11 above and a second substrate layer 15 below, a first conducting layer 12, a first friction layer 13, and a second conducting layer 14, the second conducting layer 14 being also used as a second friction layer, where the first substrate layer 11 and the first friction layer 13 are prepared by 4D printing, with the shape memory function; and the first conducting layer 12 and the second conducting layer 14 are obtained by spraying a solution with a conducting substance and volatilizing the solution. The first conducting layer 12 and the second conducting layer 14 are electrically connected.

In addition, the first friction layer 13 can also be arranged on the second conducting layer 14, so that there is a gap between the first friction layer 13 and the first conducting layer 12, and in this case, the first conducting layer 12 is used as the second friction layer.

In a specific implementation process, the triboelectric nanogenerator is prepared by way of fused deposition printing, direct ink writing printing or digital light processing printing. The first substrate layer 11, the second substrate layer 15 and the first friction layer 13 can be made of shape memory polymers or self-repair materials, and various smart materials capable of sensing external stimulation and being treated appropriately as well. The conducting substance can be a silver nanowire, a carbon nanotube or graphene. The solution can be a volatile solution.

Specifically, in the embodiment, the first substrate layer 11, the second substrate layer 15 and the first friction layer 13 are made from a polyurethane material, the conducting substance is the silver nanowire, and the solution is a methanol solution.

Under the action of a periodical external force, a clearance distance between the first substrate layer 11 and the second substrate layer 15 is compressed, resulting in continuous contacting-separating motion of the first friction layer 13 and the second conducting layer 14. Specifically, a perpendicular contacting-separating mode is adopted, so that the triboelectric nanogenerator outputs alternating electric signals outwards, wherein voltage signals are outputted in an open circuit state and current signals are outputted in a short-circuited state. In a case where an external force is applied to the first substrate layer 11 and/or the second substrate layer 15, when the first friction layer 13 and the second conducting layer 14 have equivalent positive and negative charges on surfaces due to triboelectrification, the triboelectric nanogenerator starts to work; then the external force is removed, the first friction layer 13 moves to the initial position on the first substrate layer 11 and/or the second substrate layer 15, and the external force is applied again to the first substrate layer 11 and/or the second substrate layer 15, so that the first friction layer 13 is in contact with the second conducting layer 14 again, so as to achieve a complete power generation period; and when the external force is periodically applied to the first substrate layer 11 and/or the second substrate layer 15, the above power generation period occurs circularly.

Specifically, referring to FIGS. 1-2, both ends of the first substrate layer 11 and the second substrate layer 15 can be provided with connecting portions 16, the connecting portions 16 can be arranged in curved surface shapes such as planar shape or arch shape, and sections of the first substrate layer 11, the second substrate layer 15, the first friction layer 13, the first conducting layer 12 and the second conducting layer 14 can be polygonal or curved edge-shaped, for example, rectangular or round. The connecting portion is integrally printed by the material forming the first substrate layer 11 and the second substrate layer 15 during printing. The connecting portions 16 can further be elastic components. When the external force is removed, the first friction layer 13 and the second conducting layer 14 are away from each other under the elastic force of the connecting portions, so that the first substrate layer 11 and the second substrate layer 15 are recovered to the initial positions.

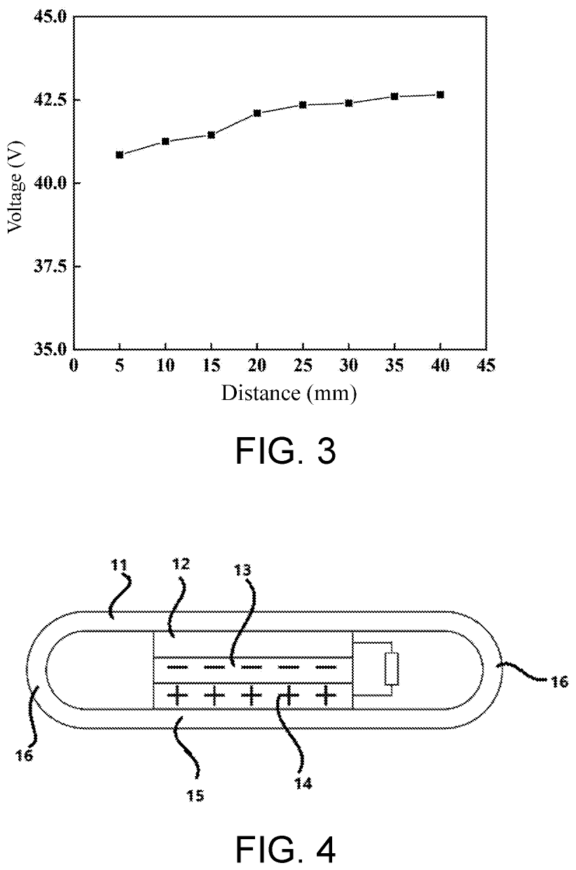

Specifically, the gap width between the first friction layer 13 and the second conducting layer 14 or the first conducting layer 12 can be set as 5 mm to 45 mm. Referring to FIG. 3, when the gap width is set as 5 mm, 10 mm, 15 mm, 20 mm, 25 mm, 30 mm, 35 mm, 40 mm and 45 mm, the corresponding peak open-circuit voltages generated by the triboelectric nanogenerator are 40.85V, 41.25V, 41.45V, 42.1V, 42.35V, 42.4V, 42.6V and 42.65V. It can be known from FIG. 3 that, with increase of the gap width, the peak open-circuit voltages of the triboelectric nanogenerator increases. When the gap width is greater than 20 mm, the amplitude of variation of the output voltage is small. In addition, since contacting-separating motion is continuously performed under the action of the external force, the separating process mainly relies on the resilience force of the material of the connecting portions. In a high frequency testing environment, when the spacing is too large, the deformed apparatus cannot rebound fully. Therefore, the width gap between the first friction layer 13 and the second conducting layer 14 or the first conducting layer 12 is selected as 20 mm.

The working principle of the triboelectric nanogenerator based on a 4D printing technology in the embodiment will be described below in combination with FIGS. 4-7.

The initial state of the triboelectric nanogenerator is shown in FIG. 1. In the initial state, all components are electrically neutral; when the first friction layer 13 and the second conducting layer 14 are in contact with each other due to the action of an external force, as shown in FIG. 4, charge transfer (triboelectrification) occurs on the interface where the two are in contact due to different electronegativities of the first friction layer 13 and the second conducting layer 14; the effective component of the first friction layer 13 in the embodiment is polyurethane and the effective component of the second conducting layer 14 is the silver nanowire. As the electronegativity of polyurethane is higher than that of the silver nanowire, the surface of the first friction layer 13 has net negative charges, the surface of the second conducting layer 14 have net positive charges, and the total charge quantities of the two equal; as centers of positive and negative charges are very close, the interfacial potential difference approaches to 0. When the conducting layers are electrically connected, there are no charges flowing in an external circuit.

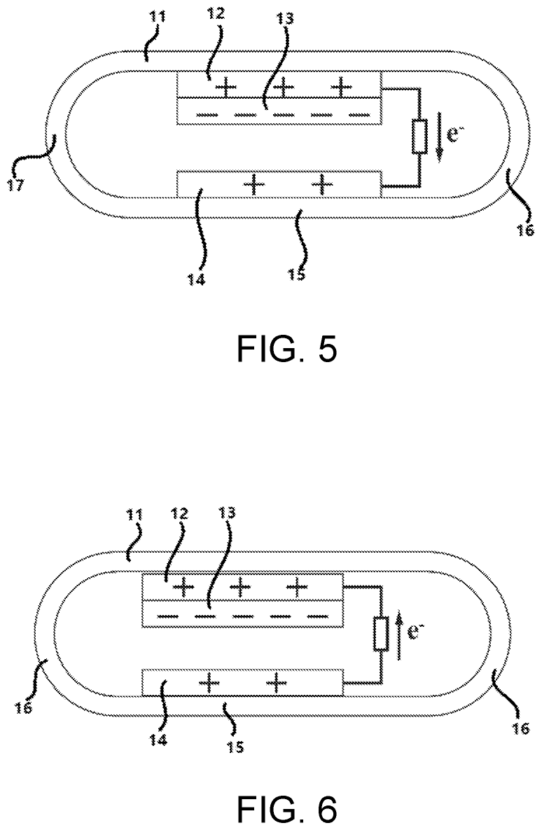

When the external force is removed, the first friction layer 13 and the second conducting layer 14 are away from each other under the action of the elastic force of the connecting portions 16. As shown in FIG. 5, as the centers of the positive and negative charges are away from each other, the potential difference exists between the interfaces; under the action of electrostatic induction, the positive charges in the first conducting layer 12 approach the interface of the first conducting layer 12 and the first friction layer 13; when the conducting layers are electrically connected, to balance the potential difference between the first friction layer 13 and the second conducting layer 14, electrons flow from the first conducting layer 12 to the second conducting layer 14.

When the first substrate layer 11 and/or the second substrate layer 15 are fully recovered to the initial positions, as shown in FIG. 6, the potential difference between the first friction layer 13 and the second conducting layer 14 is fully neutralized, so that there are no electrons flowing in the external circuit.

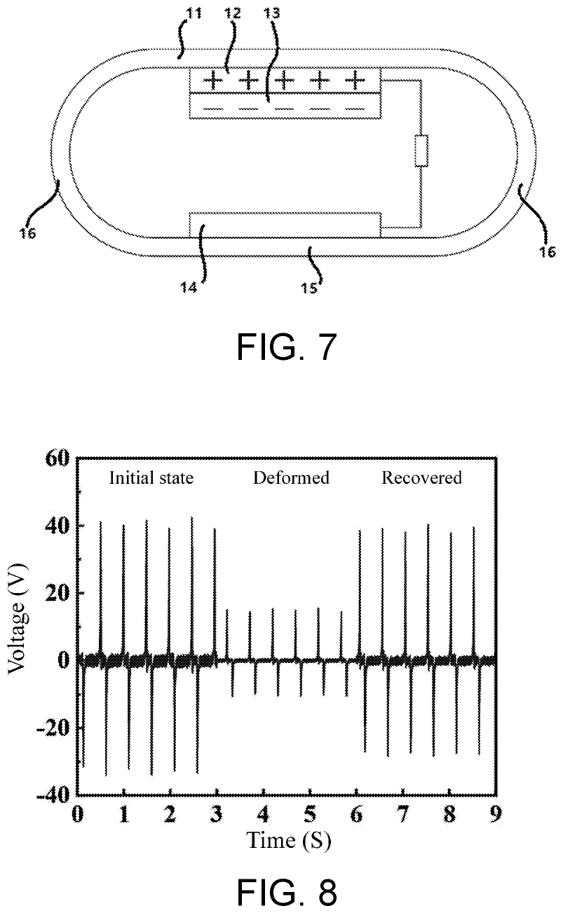

A pressure is applied to the substrates again, so that the first friction layer 13 and the second conducting layer 14 approach to each other. As shown in FIG. 7, to balance the potential difference between the first friction layer 13 and the second conducting layer 14, electrons flow from the second conducting layer 14 to the first conducting layer 12. By repeating the above process, the triboelectric nanogenerator can output an alternating electric signal outwards.

When the conducting layers are open-circuited, a voltage signal can be obtained.

It is worth noting that as the first friction layer 13 is prepared by 4D printing technology, some patterns can be designed on the surface of a model in a model design stage, for example, bulge or groove structures. When the triboelectric nanogenerator works, these patterns can increase the contact area effectively, so that the output performance of the triboelectric nanogenerator is improved.

As the triboelectric nanogenerator will perform the contacting-separating motion continuously during work, high intensity friction will cause wear of the surface of the friction layer, and the apparatus may deform due to the action of the external force. These microscopic and macroscopic deformations result in performance degradation of the triboelectric nanogenerator.

When the relative area size between the first friction layer 13 and the second conducting layer 14 is 4 cm×4 cm, and the gap between the first friction layer 13 and the first conducting layer or the second conducting layer is 20 mm, the peak open-circuit voltage generated by the triboelectric nanogenerator is 42.1V; when deformations occur, due to decrease of the effective contact area, the peak open-circuit voltage of the apparatus is attenuated to 18V; after the apparatus is heated at 60° C. for 30 s, the shape of the apparatus is recovered, and the peak open-circuit voltage of the apparatus is also recovered to 42V which is approximately equal to the initial value. It can be seen from FIG. 8 that when the apparatus deforms, the generated voltage decreases greatly; and after the shape of the apparatus is recovered, the performance is effectively recovered.

### Embodiment 2

A shoe-pad-shaped energy harvesting device is designed based on the embodiment 1. Based on the working principle of the triboelectric nanogenerator, the basic working mode of the device is a contacting-separating mode, specifically a perpendicular contacting-separating mode.

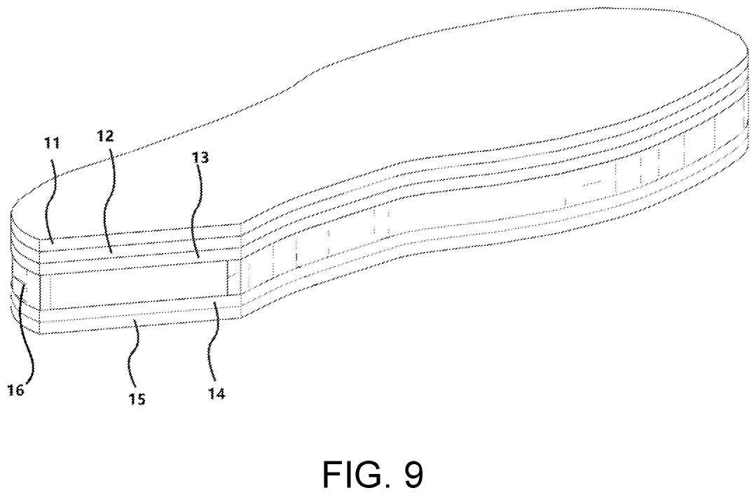

As shown in FIG. 9, the apparatus is provided with an upper substrate 11, a first conducting layer 12, a first friction layer 13, a connecting portion 16, a second conducting layer 14 and a lower substrate 15 in sequence from top to bottom, wherein the second conducting layer 14 is also used as a second friction layer. As the structure of the apparatus is similar to that in the embodiment 1 and the working principles are the same, the working principle is not described repeatedly herein. In the energy harvesting device, the perpendicular contacting-separating mode is also adopted. In consideration of the practicality of a shoe-pad, the width gap between the first friction layer 13 and the second conducting layer is selected as 20 mm.

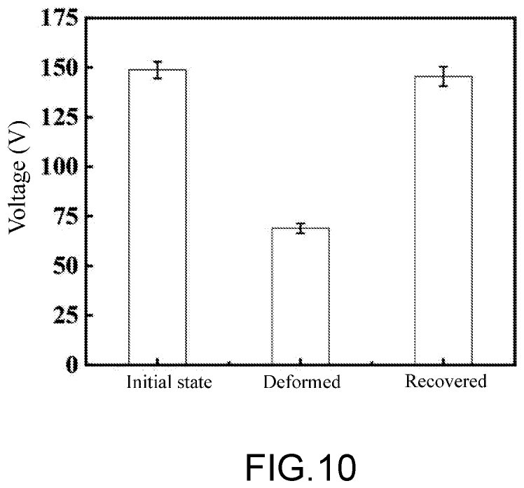

The size of the energy harvesting device in the shoe-pad shape designed in the present invention is European size 41. When a person with the body weight about 60 kg walking normally, the generated peak open-circuit voltage reaches 138V, and the peak power density reaches 56 mW/m², so that 28 LEDs can be lightened easily. As shown in FIG. 10, when the shoe-pad deforms, due to the decrease of the effective contact area, the peak open-circuit voltage is attenuated to 68V; and after the deformed shoe-pad is heated at 60° C. for 2 min, the shape of the shoe-pad is recovered, and the peak open-circuit voltage is also recovered to 135V.

### Embodiment 3

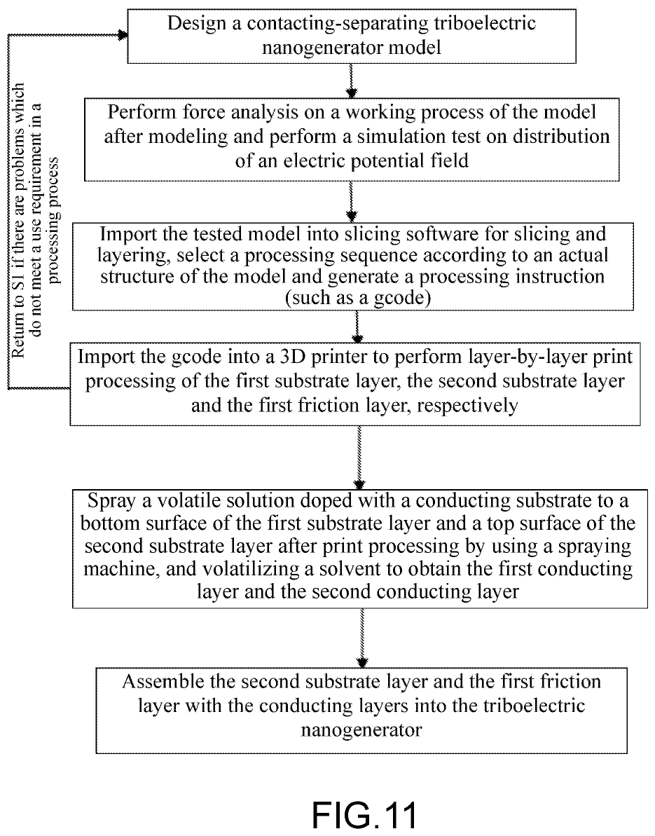

A method for preparing a triboelectric nanogenerator based on a 4D printing technology, referring to FIG. 11, including the following steps:
S1: a contacting-separating triboelectric nanogenerator model is designed;
S2: force analysis is performed on a working process of the model after modeling and a simulation test is performed on distribution of an electric potential field;
S3: the tested model is imported into slicing software for slicing and layering, a processing sequence is selected according to an actual structure of the model and a processing instruction (such as a gcode) is generated;
S4: the processing instruction (such as the gcode) is imported into a 3D printer to perform layer-by-layer print processing of the first substrate layer, the second substrate layer and the first friction layer, respectively; if a printed product has the problems of collapse, deformation of influence on assembly in the processing process, which does not meet a use requirement, it is turned to S1 to carry out design and simulation test of the model again and a novel processing instruction (such as the gcode) is generated;
S5: a volatile solution doped with a conducting substance is sprayed to a bottom surface of the first substrate layer and a top surface of the second substrate layer by using a spraying machine after print processing, and the solution is volatilized to obtain the first conducting layer and the second conducting layer; and
S6: the first substrate layer having the conducting layer, the second substrate layer having the conducting layer, and the first friction layer are assembled into the triboelectric nanogenerator.

In S2, 3DS MAX software is used for modeling, and software such as COMSOL is used for performing force analysis on a working process of the model and performing simulation test on distribution of an electric potential field.

The above method for preparing a triboelectric nanogenerator based on a 4D printing technology can be also used for manufacturing triboelectric nanogenerators with various modes, including, but not limited to, a triboelectric nanogenerator with a transverse sliding mode, a triboelectric nanogenerator with a single electrode mode and a triboelectric nanogenerator with an independent layer mode.

Same or similar marks correspond to same or similar parts.

The terms describing position relationships in the drawings are merely used for exemplary description and are not construed as limitation to the patent.

Apparently, the embodiments of the present invention are merely examples made for describing the present invention clearly and are not to limit the embodiments of the present invention. Those of ordinary skill in the art can further make modifications or variations in other forms on the basis of the above description. It is unnecessary to and unable to list all the implementation modes herein. Any modification, equivalent replacement, improvement, etc. made within the spirit and principle of the present invention shall be regarded as within the protection scope of the claims of the present invention.

1. A triboelectric nanogenerator based on a 4D printing technology, comprising:
a first substrate layer and a second substrate layer, arranged parallelly up and down;
a first conducting layer, arranged on a lower surface of the first substrate layer;
a second conducting layer, arranged on an upper surface of the second substrate layer; and
a first friction layer, arranged on a lower surface of the first conducting layer or an upper surface of the second conducting layer,
wherein the first conducting layer and the second conducting layer are electrically connected;
the first substrate layer, the second substrate layer and the first friction layer are formed by adopting the 4D printing technology; and
a gap is formed between the first friction layer and the second conducting layer or between the first friction layer and the first conducting layer, and a contacting-separating reciprocating motion is performed between the first frictional layer and the second conducting layer or between the first frictional layer and the first conducting layer.

2. The triboelectric nanogenerator based on a 4D printing technology according to claim 1, wherein the first substrate layer, the second substrate layer and the first friction layer are made of a shape memory polymer layer or a self-repair material layer.

3. The triboelectric nanogenerator based on a 4D printing technology according to claim 1, wherein the 4D printing technology is fused deposition printing, direct ink writing printing or digital photocuring.

4. The triboelectric nanogenerator based on a 4D printing technology according to claim 1, wherein a volatile solution with a conducting substance is sprayed to surfaces of the first substrate layer and the second substrate layer, and the first conducting layer and the second conducting layer are obtained by volatilizing a solvent.

5. The triboelectric nanogenerator based on a 4D printing technology according to claim 4, wherein the conducting substance comprises a silver nanowire, a carbon nanotube or graphene.

6. The triboelectric nanogenerator based on a 4D printing technology according to claim 1, wherein there are bulges or grooves on a surface of the first friction layer.

7. The triboelectric nanogenerator based on a 4D printing technology according to claim 1, wherein ends of both sides of the first substrate layer and the second substrate layer are connected by a connecting portion to form an annular structure.

8. The triboelectric nanogenerator based on a 4D printing technology according to claim 7, wherein the connecting portion, the first substrate layer and the second substrate layer are integrally printed.

9. A mechanical energy harvesting device, wherein the triboelectric nanogenerator based on a 4D printing technology according to claim 1 is prepared in a shoe-pad shape for harvesting mechanical energy generated by walking of a human body.

10. A method for preparing the triboelectric nanogenerator based on a 4D printing technology according to claim 1, comprising the following steps:
S1: designing a contacting-separating triboelectric nanogenerator model;
S2: performing force analysis on a working process of the model after modeling and performing a simulation test on distribution of an electric potential field;
S3: importing the tested model into slicing software for slicing and layering, selecting a processing sequence according to an actual structure of the model and generating a processing instruction;
S4: importing the processing instruction into a 3D printer to perform layer-by-layer print processing of the first substrate layer, the second substrate layer and the first friction layer, respectively; if a printed product in the processing process does not meet a use requirement, returning to S1 to carry out design and simulation test of the model again and generating a novel processing instruction;
S5: spraying a volatile solution doped with a conducting substance to a bottom surface of the first substrate layer and a top surface of the second substrate layer by using a spraying machine after print processing, and volatilizing a solvent to obtain the first conducting layer and the second conducting layer; and
S6: assembling the first substrate layer having the conducting layer, the second substrate layer having the conducting layer, and the first friction layer into the triboelectric nanogenerator.
